(19) United States
(12) Patent Application Publication
(10) Pub. No.: US 2012/0145339 A1
(43) Pub. Date: Jun. 14, 2012

(54) VEHICULAR SHADE ASSEMBLY

(76) Inventor: Mark Mason, Zeeland, MI (US)

(21) Appl. No.: 13/285,659

(22) Filed: Oct. 31, 2011

Related U.S. Application Data
(60) Provisional application No. 61/408,353, filed on Oct. 29, 2010.

(51) Int. Cl. B60J 3/02

(52) U.S. Cl. 160/370.22; 160/370.21

(57) ABSTRACT

A vehicular shade assembly having a shade sized to cover at least a portion of a side window of a vehicle a means for translating the shade between a retracted position and an extended position and wherein the shade is at least partially housed within a B-pillar of the vehicle when the shade is in the retracted position.

### CROSS-REFERENCE TO RELATED APPLICATION(S)

This application claims the benefit of U.S. Provisional application Ser. No. 61/408,353, filed Oct. 29, 2010, entitled “Vehicular Shade Assembly,” which is hereby incorporated herein by reference in its entirety, including all references cited therein.

### BACKGROUND OF THE INVENTION

1. Field of the Invention

The present invention relates in general to a vehicular shade assembly and, more particularly, but not by way of limitation, to a vehicular shade assembly having a shade which is adapted to be housed within the B-pillar of a vehicle and which is further adapted to selectively translate between a retracted position and an extended position to cover at least a portion of a side window of a vehicle.

2. Background Art

Vehicular shade assemblies have been known in the art for years, and are the subject of numerous patents, including: U.S. Pat. No. 4,570,991 entitled “SUN VISOR STOWED ON PILLAR,” U.S. Pat. No. 5,067,765 entitled “FLEXIBLE SUN VISOR WITH OVER-CENTER SPRING,” U.S. Pat. No. 5,575,524 entitled “DISCREET MOTOR VEHICLE WINDOW SHADE,” U.S. Pat. No. 7,401,840 entitled “WINDOW SHADE,” United States Patent Application Publication Number 2008/0315615 entitled “ELECTRIC SIDE-WINDOW ROLL-UP SHADE,” and United States Patent Application Publication Number 2008/0035284 entitled “SUN SHADE APPARATUS”—all of which are hereby incorporated herein by reference in their entirety including the references cited therein.

U.S. Pat. No. 4,570,991 appears to disclose an elongated sun visor panel of either opaque or tinted material which is pivoted on the vehicle body adjacent the juncture between the windshield pillar and the windshield header to enable pivotal movement between a vertical stored position overlying the windshield pillar and a horizontal position partially obstructing either the windshield opening or the side window opening. The elongated panel is preferably divided by a living hinge which provides a longitudinal extending hinge axis by which the panel may be folded to closely overlie the shape of the windshield pillar. A pair of sun visor panels is preferably provided to enable simultaneous shielding of the occupant relative both the windshield and the side window. The sun visor panel is preferably held in the use position and the stored position by Velcro fasteners, magnets, or a detent associated with the pivot.

U.S. Pat. No. 5,067,765 appears to disclose a flexible sun shading membrane that has an edge coupled to a window frame and an opposite edge attached to a moveable member which has at least two stable positions, one being closed adjacent and conforming to the window frame and a second position extended and lowered from the window frame to stretch the membrane into a sun blocking position.

U.S. Pat. No. 5,575,524 appears to disclose a combination of a window shading device and a rigid window frame of a motor vehicle windshield. The windshield is supported in a rigid window frame. The combination includes a cover disposed over a portion of the rigid window frame to provide a pleasing aesthetic appearance.

U.S. Pat. No. 7,401,840 appears to disclose a window shade stored on a storage roller mounted beneath a vehicle window opening. A trim panel has a slot through which the window shade may be unwound and raised to a use position shading the window. One or more hooks are attached to the window shade to engage with mating hook retainers at the top of the window opening to retain the window shade in its raised position. The lowered position of the window shade is established by the hook being engaged with a corresponding hook retainer on the trim panel. A finger grip is pivotally mounted on the upper end of the window shade so that the finger grip can have a predetermined pivotal position corresponding to the lowered position of the window shade and a different pivotal position when the window shade is in the raised position.

United States Patent Application Publication Number 2008/0315615 appears to disclose a side-window roll-up shade for the front doors of motor vehicles which has a relatively short wind-up shaft housed in the region of a back edge of the window in the door frame. A short guide rail extends above the top edge of the window for guiding a slide, which is connected to a tip of the roll-up shade. For driving the roll-up shade, an electric drive with a cord is provided, with the cord extending around the window opening as a closed loop.

United States Patent Application Publication Number 2008/0035284 appears to disclose a sunshade apparatus of the present invention has a curtain capable of shielding a window portion of a door. The curtain can be stretched between a shielding state and an open state on the window portion. The apparatus has a motor, a cable provided so as to be capable of being forced out or drawn in by the operation of the motor, and a connector connecting the cable and the curtain to each other. The curtain is stretched with the operation for forcing out or drawing in the cable. The connector has a connection release mechanism releases the cable and the curtain from the state of being connected when a load equal to or higher than a predetermined value is applied against the operation for forcing out or drawing in the cable.

While the above-identified patents and publications do appear to provide vehicular shade assemblies, their configurations remain non-desirous and/or problematic inasmuch as, among other things, none of the above-identified assemblies appear to be configured to house the shade within the B-pillar of the vehicle—among other things.

It is therefore an object of the present invention to provide a vehicular shade assembly, which, among other things, remedies the aforementioned detriments and/or complications associated with the use of the above-identified, conventional vehicular shade assemblies. It is further therefore an object of the present invention to provide a vehicular shade assembly having a shade which is adapted to be housed within the B-pillar of a vehicle and which is further adapted to selectively translate between a retracted position and an extended position to cover at least a portion of a side window of a vehicle.

These and other objects of the present invention will become apparent in light of the present specification, claims, and drawings.

### SUMMARY OF THE INVENTION

In one embodiment, the present invention is directed to a vehicular shade assembly, comprising: (a) a shade sized to cover at least a portion of a side window of a vehicle; (b) means for laterally translating the shade between a retracted position and an extended position; and (c) wherein means for laterally translating the shade between a retracted position and an extended position is at least partially housed within a B-pillar of the vehicle.

In another embodiment, the shade is sized to cover a top portion of the side window of the vehicle.

In yet another embodiment, means for translating includes: (i) a bracket pivotally connected to the B-pillar of the chassis of the vehicle; (ii) a spool rotatably supported by the bracket; and (iii) means for wrapping and unwrapping the shade onto the spool in such a way that the shade can selectively translate laterally between the retracted position and the extended position.

In an additional embodiment, means for translating further includes: (iv) a guide channel disposed above the side window of the vehicle, wherein a top edge of the shade is disposed within the guide channel, and further wherein the top edge of the shade is sized to be retained within the guide channel when the shade translates along the guide channel.

In another embodiment, means for wrapping and unwrapping includes an electric motor for rotating the spool.

In one embodiment, means for wrapping and unwrapping includes: (i) a cable attached to the spool and positioned above the shade, wherein the cable is connected to at least a portion of the top edge of the shade, and further wherein the cable is looped around a pulley disposed forwardly of the B-pillar of the chassis of the vehicle; and (ii) wherein when the shade is translated from the retracted position to the extended position, the shade is unwrapped from the spool while the cable is wrapped around the spool, and wherein when the shade is translated from the extended position to the retracted position, the cable is unwrapped from the spool while the shade is wrapped around the spool.

In one aspect of the present invention, the guide channel is disposed behind a headliner of the vehicle and the shade extends through the headliner.

In accordance with the present disclosure, the portion of the cable connected to the top edge of the shade is sized to prevent the shade from being removed from the guide channel as the shade translates along the guide channel.

In one embodiment the present invention is directed to a vehicular shade assembly, comprising: (a) a bracket pivotally connected to a B-pillar of a chassis of a vehicle; (b) a spool rotatably supported by the bracket; (c) a shade having at least one end connected to the spool, wherein the shade is sized to cover at least a portion of the side window of the vehicle; and (d) means for wrapping and unwrapping the shade onto the spool in such a way that the shade can selectively translate laterally between a retracted position and an extended position.

In yet another embodiment, the assembly further includes: (e) a guide channel disposed above the side window of the vehicle, wherein a top edge of the shade is disposed within the guide channel, and further wherein the top edge of the shade is sized to be retained within the guide channel when the shade translates along the guide channel.

In one embodiment, means for wrapping and unwrapping includes an electric motor which can rotate the spool.

In another embodiment, means for wrapping and unwrapping includes: (i) a cable attached to the spool, wherein the cable is connected to at least a portion of the top edge of the shade, and further wherein the cable is looped around a pulley disposed forwardly of the B-pillar of the chassis of the vehicle; and (ii) wherein when the shade is translated from the retracted position to the extended position, the shade is unwrapped from the spool while the cable is wrapped around the spool, and wherein when the shade is translated from the extended position to the retracted position, the cable is unwrapped from the spool while the shade is wrapped around the spool.

In one aspect of the present invention, the guide channel is disposed behind a headliner of the vehicle and the shade extends through the headliner.

In yet another embodiment, the portion of the cable connected to the top edge of the shade is sized to prevent the shade from being removed from the guide channel as the shade translates along the guide channel.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

The invention will now be described with reference to the drawings wherein:

FIG. 1 of the drawings is side elevation view of a portion of a vehicular shade assembly covering a top portion of a side window of a vehicle;

FIG. 2 of the drawings is a side elevation view of a vehicular shade assembly attached to a chassis of a vehicle;

FIG. 3 of the drawings is a perspective view of a portion of the vehicular shade assembly in a retracted position;

FIG. 4 of the drawings is a perspective view of the vehicular shade assembly illustrating a cable and pulley, the vehicular shade assembly being shown in an extended position; and

FIG. 5 of the drawings is an end view of the guide channel of the vehicular shade assembly showing the shade and cable disposed within the guide channel.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters.

In general, the present invention is directed to a vehicular shade assembly having a shade which is adapted to be housed within the B-pillar of a vehicle and which is further adapted to selectively translate between a retracted position and an extended position to cover at least a portion of a side window of a vehicle.

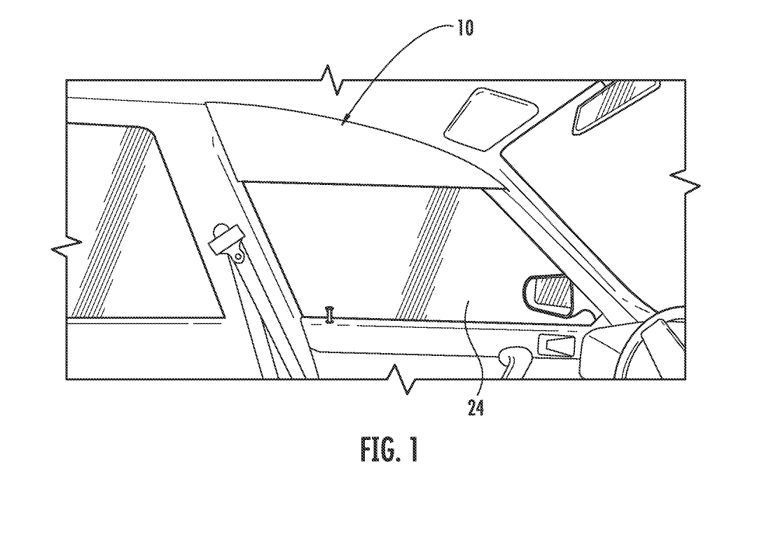

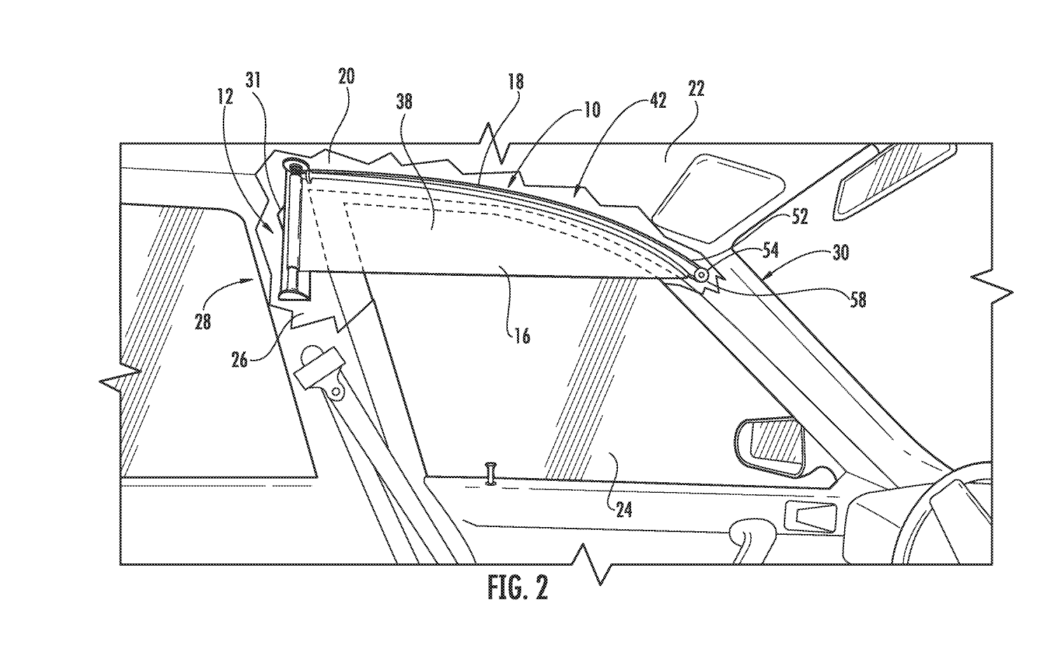

Referring now to the collective drawings (i.e., FIGS. 1-5), vehicular shade assembly, hereinafter referred to as assembly 10, generally includes bracket 12, spool 14, shade 16, and guide channel 18. Assembly 10 is housed between chassis 20 of vehicle 22 and trim panels (not shown) that include the headliner along with both A and B pillar panels. More specifically, bracket 12 and spool 16 of assembly 10 are positioned behind side window 24 and secured to B-pillar frame member 26. Guide channel 18 is positioned above top portion of side window 24 generally following the contour of side window 24. Guide channel 18 terminates a predetermined distance away from B-pillar 28, preferably proximate A-pillar 30.

Although not shown, it will be understood that because assembly 10 is disposed behind the trim panels of vehicle 22, the trim panels may include slits or openings configured to allow shade 16 to enter and exit from the trim panels.

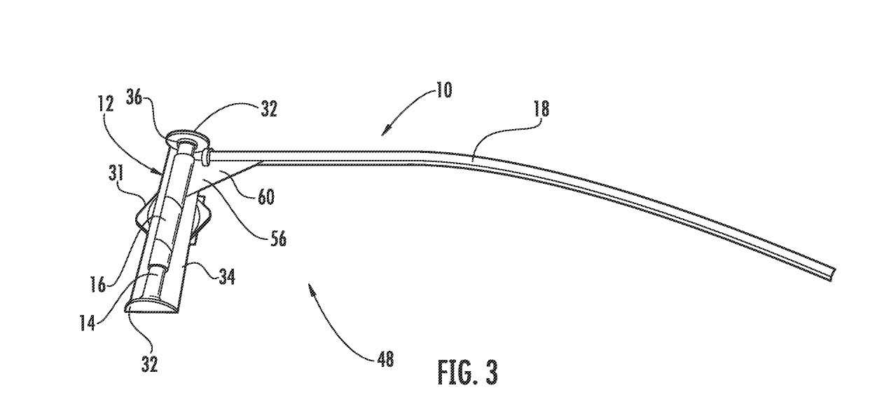

Bracket 12 is provided for rotatably supporting spool 14. Bracket 12 is preferably a strong and rigid support member fabricated from a material or a combination of materials such as metal, metallic alloys, plastic, resin, composite materials, natural materials, or combinations thereof. Bracket 12 is pivotally connected to B-pillar frame member 26 via pivoting bracket 31 (see FIG. 3) which is secured to B-pillar frame member 26. Pivoting bracket 31 allows for limited movement of bracket 12 thereby allowing spool 14 to move during operation to prevent warping and/or twisting of shade 16 during operation.

In one embodiment, bracket 12 includes support plates 32 extending perpendicularly from base member 34. Support plates 32 are positioned at the top and bottom of base member 34 and are spaced apart from one another to accommodate spool 14. Support plates 32 include one or more rotatable members 36, which interface with spool 14 and allow spool 14 to freely rotate in both clockwise and counterclockwise fashion. Rotatable members 36 may include, for example, bearings or axles. It will be understood that while spool 14 has been disclosed as interfacing with rotatable members 36 on bracket 12, other suitable components or devices for rotatably supporting spool 14 on B-pillar frame member 26 of vehicle 22 that would be known to one of ordinary skill in the art with the present disclosure before them are likewise contemplated for use in accordance with the present invention.

Spool 14 is a tubular member or shaft adapted to interface with shade 16 and a cable as will be discussed in greater detail below. Spool 14 is preferably a strong and rigid member fabricated from a material or a combination of materials such as metal, metallic alloys, plastic, resin, composite materials, natural materials, or combinations thereof.

Guide channel 18 includes a rigid and substantially U-shaped channel having an opening 38 extending along the length of guide channel 18. Guide channel 18 provides a path for selective translation of shade 16 and a cable as will be discussed in greater detail below. Guide channel 18 extends linearly away from bracket 12 but is shaped having a substantially angled portion formed such that guide channel 18 may substantially conform to the shape of top portion of side window 24.

Guide channel 18 is configured to receive and retain at least a portion of shade 16. For example, guide channel 18 may include one or more flanges 40 covering at least a portion of opening 38. Flanges 40 are provided to retain at least a portion of shade 16 within guide channel 18 while allowing shade 16 to selectively translate along the length of guide channel 18. Exemplary configurations of shade 16 will be discussed in greater detail below.

Guide channel 18 may be attached to chassis portion 42 above side window 24. Guide channel 18 may be attached to chassis portion 42 via a plurality of fasteners (now shown) placed through a sidewall of guide channel 18 into chassis portion 42. Also, guide channel 18 may be attached with one or more brackets (also not shown). While guide channel 18 has been disclosed as being attached to chassis portion 42 via a plurality of fastener brackets, guide channel 18 may be attached to chassis portion 42 via any suitable attachment means, for example, adhesives, rivets, clips, welding, or the like. It will be understood that guide channel 18 may be alternatively disposed on the outer surface of headliner (not shown).

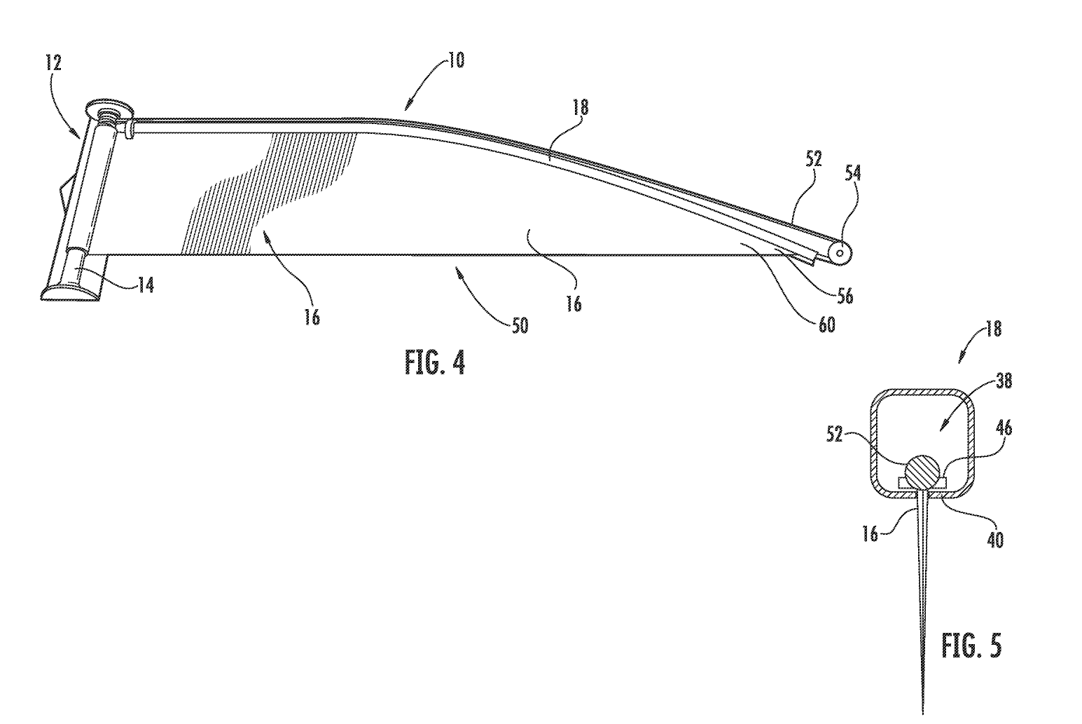

Shade 16 includes a flexible sheet of material that is at least one of transparent, translucent, opaque, perforated, or any combination of thereof. Shade 16 may be fabricated from a variety of materials such as a cloth, a plastic, a natural material, or any combination thereof. Shade 16 is shaped to cover at least a portion of top portion of side window 24. At least one end of shade 16 is fixed to spool 14 such that when spool 14 is rotated, shade 16 is wrapped or unwrapped onto spool 14, depending on the direction of rotation of spool 14. Shade 16 is selectively translatable between retracted position 48 (see FIG. 3) and extended position 50 (see FIG. 4) via any number of different means as will be discussed in greater detail below. Additionally, top edge 46 of shade 16 may be provided with a thickening such that top edge 46 fits within opening 38 of guide channel 18. Furthermore, top edge 46 is sized such that flanges 40 of guide channel 18 prevent shade 16 from being removed from guide channel 18 as shade 16 translates along guide channel 18. By way of non-limiting example, top edge 46 includes a horizontal portion such that shade 16 has a substantially T-shaped cross section.

In one non-limiting example, assembly 10 is provided with cable 52 and pulley 54 for selectively translating shade 16 along guide channel 18 and wrapping and unwrapping shade 16 onto spool 14. More specifically, cable 52 is attached to leading edge 56 of shade 16 and is at least partially disposed within guide channel 18. It will be understood that the portion of cable 52 that is disposed within guide channel 18 has a diameter of a sufficient size to prevent cable 52 from exiting past flanges 40 of guide channel 18 to retain cable 52 within guide channel 18. Cable 52 is looped around pulley 54 that is fixed to A-pillar frame member 58 (see FIG. 1) such that pulley 54 may freely rotate. Cable 52 also extends over the top of guide channel 18 where one end of cable 52 is attached to spool 14. It will be understood that the portion of cable 52 that wraps around spool 14 may be of smaller diameter than the portion of cable 52 attached to leading edge 56 of shade 16 to facilitate efficient wrapping of cable 52 around spool 14.

It will be understood that cable 52 is attached to spool 14 in such a way that counterclockwise rotation of spool 14 causes shade 16 to unwrap from spool 14 and cable 52 to wrap onto spool 14. Clockwise rotation of spool 14 causes an inverse effect. Cable 52 has a length of sufficient size to maintain constant tension to keep shade 16 in a taut configuration as it selectively translates along guide channel 18 to prevent warping of shade 16.

In accordance with the present invention, leading edge 56 of shade 16 extends from B-pillar 28 when shade 16 is in retracted position 48 to provide tab 60 for manually actuating assembly 10. More specifically, when tab 60 is pulled along guide channel 18, shade 16 is selectively translated from retracted position 48 to extended position 50.

In operation, assembly 10 is attached to vehicle 22 as described above. Once assembly 10 is attached to vehicle 22, trim panels are installed to cover assembly 10 with the exception of tab 60 of shade 16 that extends outside of trim panels. To selectively translate shade 16 from retracted position 48 to extended position 50, a user grabs tab 60 and pulls tab 60 along guide channel 18. As shade 16 selectively translates from retracted position 48 to extended position 50 along guide channel 18, shade 16 unwraps from spool 14 causing spool 14 to rotate in a counterclockwise fashion. The counterclockwise rotation of spool 14 causes cable 52 to wrap onto spool 14 keeping cable 52 taut to prevent shade 16 from warping.

To selectively translate shade 16 from extended position 50 to retracted position 48, a user grabs tab 60 and pulls tab 60 along guide channel 18 towards B-pillar 28. As shade 16 selectively translates from extended position 50 to retracted position 48, cable 52 attached to shade 16 is unwrapped from spool 14 causing spool 14 to be rotated in a clockwise fashion. The clockwise rotation of spool 14 causes shade 16 to wrap onto spool 14.

In an additional embodiment, assembly 10 is provided with electric motor 62 attached to spool 14 to rotate spool 14 and cause shade 16 and cable 52 to wrap and unwrap onto spool 14 in the manner described above. Electrical motor 62 causes spool 14 to rotate and therefore shade 16 may selectively translate between retracted position 48 to extended position 50 and vice versa. As one of ordinary skill in the art will appreciate, the operation and control of electric motors 62 is well known and as such will not be discussed in detail.

In an alternative embodiment, spool 14 may be configured to translate vertically as spool 14 is rotated. Because leading edge 56 of shade 16 moves downwardly as shade 16 selectively translates from retracted position 48 to extended position 50, shade 16 may tend to warp or deform during translation as spool 14 is fixed to bracket 12. Vertical translation of spool 14 during wrapping and unwrapping of shade 16 from spool 14 may reduce the tendency of shade 16 to warp or deform during translation. Therefore, spool 14 may cooperate with a helical shaft (not shown) which causes spool 14 to translate upwardly along the helical shaft when shade 16 selectively translates from retracted position 48 to extended position 50. Likewise, spool 14 may cooperate with the helical shaft to cause spool 14 to translate downwardly along the helical shaft when shade 16 selectively translates from extended position 50 to retracted position 48.

The foregoing description merely explains and illustrates the invention and the invention is not limited thereto and those skilled in the art having the disclosure before them will be able to make modifications without departing from the scope of the invention.

What is claimed and desired to be secured by Letters Patent of the United States is:

1. A vehicular shade assembly, comprising:
a shade sized to cover at least a portion of a side window of a vehicle;
means for laterally translating the shade between a retracted position and an extended position; and
wherein means for laterally translating the shade between a retracted position and an extended position is at least partially housed within a B-pillar of the vehicle.

2. The assembly of claim 1, wherein the shade is sized to cover a top portion of the side window of the vehicle.

3. The assembly of claim 1, wherein means for translating includes:
a bracket pivotally connected to the B-pillar of a chassis of the vehicle;
a spool rotatably supported by the bracket; and
means for wrapping and unwrapping the shade onto the spool in such a way that the shade can selectively translate laterally between the retracted position and the extended position.

4. The assembly of claim 3, wherein means for translating further includes:
a guide channel disposed above the side window of the vehicle, wherein a top edge of the shade is disposed within the guide channel, and further wherein the top edge of the shade is sized to be retained within the guide channel when the shade translates along the guide channel.

5. The assembly of claim 3, wherein means for wrapping and unwrapping includes an electric motor for rotating the spool.

6. The assembly of claim 3, wherein means for wrapping and unwrapping includes:
a cable attached to the spool and positioned above the shade, wherein the cable is connected to at least a portion of the top edge of the shade, and further wherein the cable is looped around a pulley disposed forwardly of the B-pillar of the chassis of the vehicle; and
wherein when the shade is translated from the retracted position to the extended position, the shade is unwrapped from the spool while the cable is wrapped around the spool, and wherein when the shade is translated from the extended position to the retracted position, the cable is unwrapped from the spool while the shade is wrapped around the spool.

7. The assembly of claim 4, wherein the guide channel is disposed behind a headliner of the vehicle and the shade extends through the headliner.

8. The assembly of claim 6, wherein the portion of the cable connected to the top edge of the shade is sized to prevent the shade from being removed from the guide channel as the shade translates along the guide channel.

9. A vehicular shade assembly, comprising:
a bracket pivotally connected to a B-pillar of a chassis of a vehicle;
a spool rotatably supported by the bracket;
a shade having at least one end connected to the spool, wherein the shade is sized to cover at least a portion of the side window of the vehicle; and
means for wrapping and unwrapping the shade onto the spool in such a way that the shade can selectively translate laterally between a retracted position and an extended position.

10. The assembly of claim 9, wherein the assembly further includes:
a guide channel disposed above the side window of the vehicle, wherein a top edge of the shade is disposed within the guide channel, and further wherein the top edge of the shade is sized to be retained within the guide channel when the shade translates along the guide channel.

11. The assembly of claim 9, wherein means for wrapping and unwrapping includes an electric motor which can rotate the spool.

12. The assembly of claim 9, wherein means for wrapping and unwrapping includes:
a cable attached to the spool, wherein the cable is connected to at least a portion of the top edge of the shade, and further wherein the cable is looped around a pulley disposed forwardly of the B-pillar of the chassis of the vehicle; and
wherein when the shade is translated from the retracted position to the extended position, the shade is unwrapped from the spool while the cable is wrapped around the spool, and wherein when the shade is translated from the extended position to the retracted position, the cable is unwrapped from the spool while the shade is wrapped around the spool.

13. The assembly of claim 10, wherein the guide channel is disposed behind a headliner of the vehicle and the shade extends through the headliner.

14. The assembly of claim 12, wherein the portion of the cable connected to the top edge of the shade is sized to prevent the shade from being removed from the guide channel as the shade translates along the guide channel.
